(19) United States
(12) Patent Application Publication
(10) Pub. No.: US 2020/0096754 A1
(43) Pub. Date: Mar. 26, 2020

(54) HIGH THROUGHPUT LIGHT SHEET MICROSCOPE WITH ADJUSTABLE ANGULAR ILLUMINATION

(71) Applicant: Brendan Brinkman, Hopkinton, MA (US)

(72) Inventor: Brendan Brinkman, Hopkinton, MA (US)

(21) Appl. No.: 16/137,240

(22) Filed: Sep. 20, 2018

(51) Int. Cl. G02B 21/06; G02B 21/16; G02B 21/26; G02B 21/36; G02B 26/02; G02F 1/29; G02B 21/02; G02B 27/00

(52) U.S. Cl. CPC G02B 21/06; G02B 21/16; G02B 21/26; G02B 27/0025; G02B 26/02; G02F 1/29; G02B 21/02; G02B 21/367

(57) ABSTRACT

A light sheet microscope comprises a detection optics with a tilted focal plane, and an illumination optics generating a tilted light sheet. The light sheet may be rotated about a rotation axis in order to match the tilted focal plane. A multiple sample carrier translates multiple samples through the tilted light sheet in a translation direction which is not in the plane of the light sheet, thereby enabling acquisition of three-dimensional images of each of the multiple samples in a single pass through the light sheet.

### FIELD OF THE INVENTION

The invention relates in general to high throughput imaging of samples with a light sheet microscope, and in particular to a light sheet microscope with adjustable angular illumination and angled detection for high throughput imaging of multiple samples.

### BACKGROUND OF THE INVENTION

In light sheet microscopes of existing practice, a substantially planar sheet of light enters a sample along a direction intersecting the detection light axis of a detection optical system. A three-dimensional image of the specimen is acquired by means of fluorescence radiation from the specimen that is detected by the detection optical system. Because no regions other than the image acquisition plane are irradiated with light, it is possible to acquire a superior three-dimensional image of the sample.

Today, this technique is gaining attention not only as a technique for obtaining a three-dimensional image of a living organism in which target molecules are labeled with fluorescent proteins, but also as a technique that is applied to drug development screening, in which pharmaceutical efficacy is evaluated by obtaining three-dimensional images of cultured cells and tissues, such as spheroids or organoids (artificial organs or portions thereof). When used for drug development screening, the technique is generally applied to a large number of samples, usually arrayed in a multi-sample carrier. In such cases, throughput of the sample analysis is a key parameter defining the efficiency and cost-effectiveness of the screening process. However, in light sheet microscopes of existing practice the throughput is limited by the need to make a separate fluorescent light acquisition for each imaging plane of the sample. Furthermore, light sheet configurations such as those disclosed by Siebenmorgen et al in US patent publications 2016/0154236 and 2017/0269345 propose structures which require illumination and detection objectives above or below the sample, the objectives being disposed at some angle to the (horizontal) sample translation direction. Such light sheet configurations may unnecessarily constrain the sample and be difficult to optimize optically. The solution proposed herein describes a simple structure which can achieve high throughput screening.

Brinkman and Shimada (European Patent Application EP3293559) have disclosed a multi-sample carrier for a light sheet microscope, the carrier comprising a rotating wheel or linear translation which enable samples to be rapidly translated horizontally through a horizontally oriented planar light sheet. Data is thereby acquired from a single plane of each of the samples. However, in order to obtain a full three-dimensional image of each sample, the horizontal stage translations must be stopped and a separate acquisition must be made for each desired imaging plane within the samples, with either the sample or the light sheet being moved in a vertical axis between successive imaging planes. Such sequential imaging is time consuming and limits the sample imaging throughput and therefore the cost-effectiveness of the image acquisition.

There therefore exists a need in existing practice for a higher throughput sample imaging light sheet microscope system having a simple optical structure.

### SUMMARY OF THE INVENTION

Accordingly, it is a general objective of the present disclosure to have a high throughput sample imaging light sheet microscope.

This and other objectives are achieved by having a light sheet microscope which creates one or more light sheet illuminations that can be rotated around a rotation axis, together with an optical element that allows the detection objective to match a corresponding angled focal plane. Multiple samples are then swept through the sheet illumination by translating the samples in a translation direction, wherein the translation direction is not in the plane of the angled light sheet. In a preferred embodiment, the translation direction is perpendicular to the rotation axis and to the axis of the detection objective. In a single sweep of samples through the angled light sheet, a complete three-dimensional imaging data set is thereby generated for all the samples, allowing high throughput screening in three dimensions.

### BRIEF DESCRIPTION OF THE DRAWINGS

FIG. 1A is a schematic top view of a first embodiment of an optical system for a light sheet microscope according to the present disclosure.

FIG. 1B is a schematic top view of a first embodiment of an optical system for a light sheet microscope showing a cylindrical lens according to the present disclosure.

FIG. 1C is a schematic side view of a first embodiment of an optical system for a light sheet microscope according to the present disclosure.

FIG. 1D is a schematic top view of a second embodiment of an optical system for a light sheet microscope according to the present disclosure.

FIG. 2A is a schematic top view of a third embodiment of an optical system for a light sheet microscope according to the present disclosure.

FIG. 2B is a schematic side view of a third embodiment of an optical system for a light sheet microscope according to the present disclosure.

FIG. 3A is a partial schematic side view of an optical system for a light sheet microscope.

FIG. 3B is a partial schematic end view of an optical system for a light sheet microscope.

FIG. 3C is a partial schematic end view of an optical system for a light sheet microscope, showing rotation of the light sheet.

FIG. 4A is a schematic illustration showing alignment of a rotatable light sheet and a tilted detection plane.

FIG. 4B is an illustration of a tilting device comprising a prism.

FIG. 4C is an illustration of a tilting device comprising a mirror.

FIG. 4D is an illustration of a tilting device comprising a graded refractive index lens

FIG. 5A is a diagram showing a light sheet intersecting a sample in a sample holder.

FIG. 5B is an expanded view of a sample showing planes of intersection of a light sheet.

FIG. 6 is a diagram showing intersection of a light sheet with multiple samples in a multiple sample carrier.

FIG. 7 is a flowchart of a method of adjusting an optical system of a light sheet microscope according to the present disclosure.

FIG. 8 is a flowchart of a method of forming three-dimensional images of multiple samples according to the present disclosure.

### DETAILED DESCRIPTION OF PREFERRED EMBODIMENT

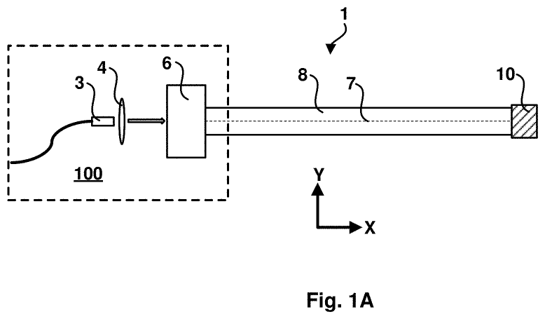

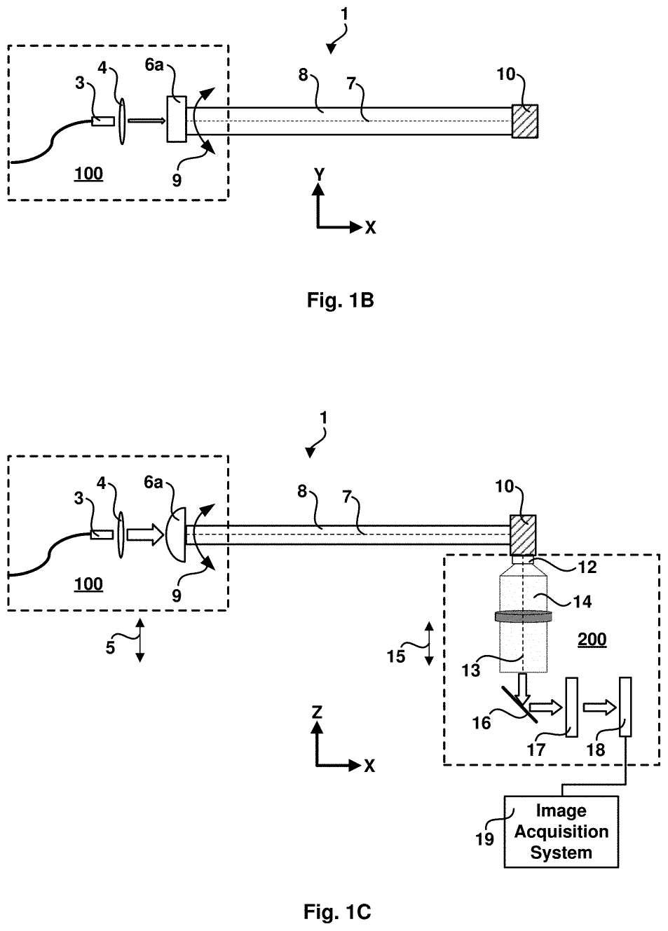

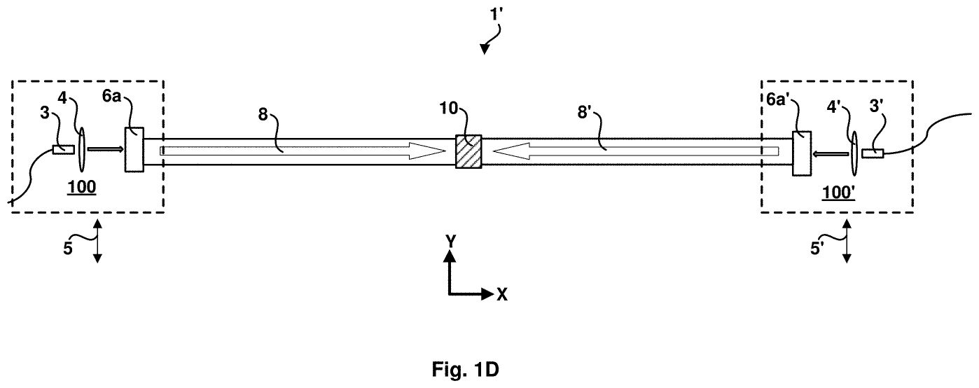

Note that for purposes of clear exposition, co-ordinates indicating X, Y, and Z directions are associated with FIGS. 1 through 4. The orientation of these co-ordinates only defines illustrative and instructive embodiments and should not be construed as defining any particular orientation of the illustrated optical systems.

FIG. 1A is a schematic top view of an optical system 1 for a light sheet microscope. Optical system 1 comprises an illumination optics 100 comprising a fiber laser 3 whose light output is collimated by a collimator 4. The collimated light enters a light sheet rotation device 6 which serves the dual functions of creating a light sheet 8 and of rotating light sheet 8 about a rotation axis 7.

FIG. 1B is a schematic top view of optical system 1 showing a cylindrical lens 6a which is an embodiment of light sheet rotation device 6. As indicated by a rotation arrow 9, cylindrical lens 6a may be rotated about rotation axis 7, thereby causing rotation of light sheet 8 about rotation axis 7. Note that cylindrical lens 6a is an embodiment capable of performing both of the dual functions of light sheet rotation device 6: the optical properties of cylindrical lens 6a form light sheet 8 from a substantially cylindrical input light beam, and rotation of cylindrical lens 6a causes rotation of light sheet 8 about rotation axis 7. Note also that rotation axis 7 is substantially perpendicular to an optical axis 13 (see FIG. 1B). Cylindrical lens 6a may be mounted on a rotation mechanism, which may be motorized enabling automated control of the rotation. Light sheet 8 illuminates a sample 10, which may be a biological sample, a sample for pharmaceutical screening, a phantom sample, or any other material for analysis with the light sheet microscope.

Note that cylindrical lens 6a is a preferred embodiment of light sheet rotation device 6 configured to form and rotate light sheet 8. However other optical devices may be used: for example, a spatial light modulator comprising electronic rotation of light sheet 8 may be used in place of mechanical rotation of cylindrical lens 6a. Generally, any suitable optical device or system may be used to form light sheet 8 and to rotate the plane of light sheet 8 about rotation axis 7, and all such optical devices or systems are within the scope of the present disclosure.

FIG. 1C is a side view of optical system 1, showing a detection optics 200 comprising an objective lens 14 which collects light emitted from sample 10. In the case of reflectance microscopy, objective lens 14 may also collect light reflected from sample 10. Objective lens 14 directs the light to a reflecting mirror 16 which further directs the light to a light detecting device 18. In a preferred embodiment optical axis 13 of objective lens 14 is in a substantially vertical orientation, and rotation axis 7 is in a substantially horizontal orientation. Light detecting device 18 is a two-dimensional light detector capable of measuring a two-dimensional light intensity distribution in a plane of intersection of light sheet 8 with sample 10. In a preferred embodiment, light detecting device 18 is a digital camera such as a charge coupled device (CCD) camera. Light detecting device 18 is connected to an image acquisition system 19 configured to acquire and display an image of sample 10.

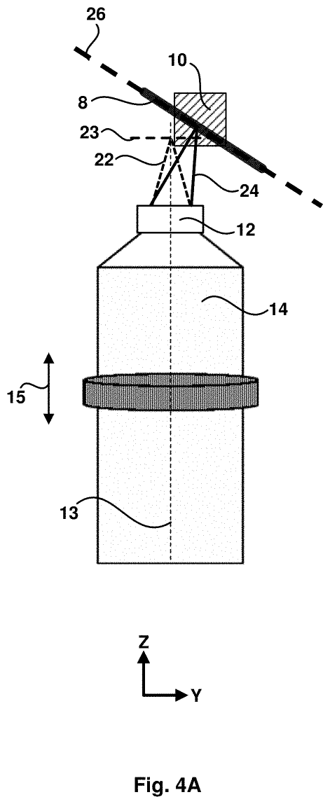

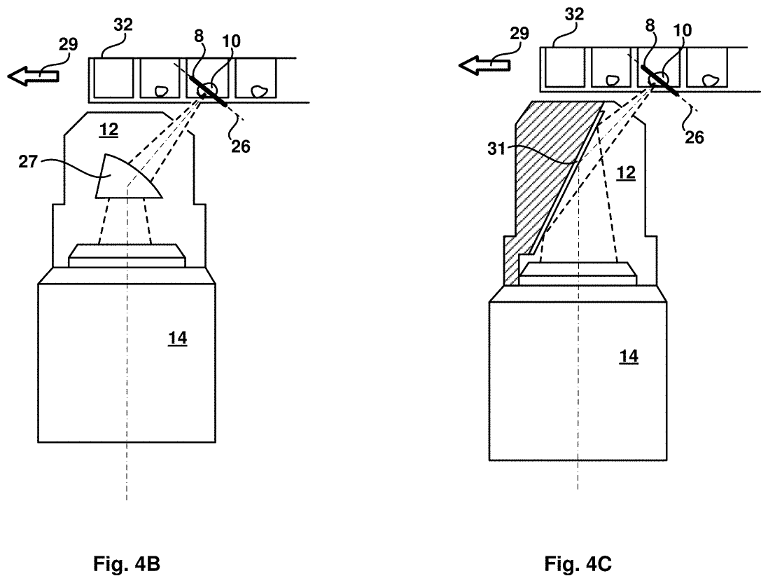

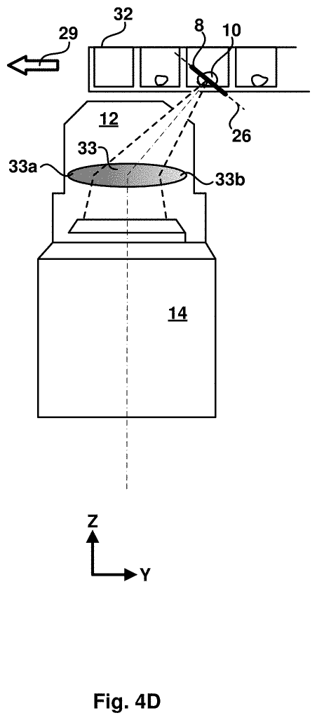

Continuing to refer to FIG. 1C, and with reference also to FIG. 4A, a tilting device 12 is configured to tilt the focal plane of objective lens 14. In the absence of tilting device 12, the focal plane of objective lens 14 is generally a normal focal plane 23 (see FIG. 4A) perpendicular to optical axis 13. In the presence of tilting device 12, the focal plane of objective lens 14 is a tilted focal plane 26 which is tilted at an angle with respect to normal focal plane 23. Tilting device 12 may be incorporated within the optical system of objective lens 14, or tilting device 12 may be a separate optical system as shown in FIG. 1C.

In order to translationally align light sheet 8 with tilted focal plane 26 or with a second light sheet (see FIG. 1D), illumination optics 100 may optionally be placed in an assembly (not shown) that translates in a sheet translation direction 5 lying in the YZ plane. In an embodiment, sheet translation direction 5 may be in the vertical Z direction.

In order to optimize the focus, detection optics 200 may optionally be placed in an assembly (not shown) that translates in a detection translation direction 15, which is preferably in the vertical Z direction. Alternatively, objective lens 14 may be fitted with an electronic focusing device (not shown) which may be adjusted to optimize the focus.

Any mechanisms or mechanical arrangements known in the art may be used for achieving motion in translation directions 5 or 15, and these mechanisms may be motorized and automated for convenience of adjustment.

Still referring to FIG. 1C, an optional aberration correction device 17 is shown between reflecting mirror 16 and light detecting device 18. The function and operation of aberration correction device 17 are described below.

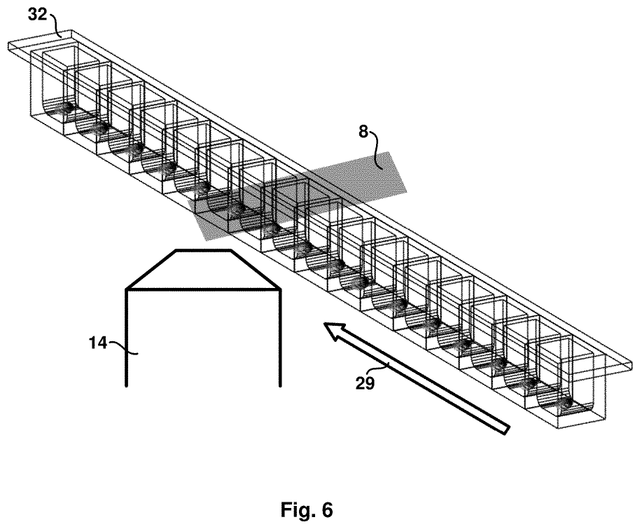

Note that the structure of optical system 1 is much simpler than that of Siebenmorgen et al. which employs illumination and detection optics disposed at some angle from the sample translation direction. In contrast, optical system 1 comprises a detection optics which is vertical and perpendicular to a sample translation direction 29 (see FIG. 6). This means that optical system 1 may be implemented on a standard inverted microscope system.

FIG. 1D is a schematic top view of an optical system 1′ for a light sheet microscope. Optical system 1′ comprises rotatable light sheet 8 incident on one side of sample 10, and a second rotatable light sheet 8′ incident on an opposite side of sample 10. Rotatable light sheet 8′ is generated by an illumination optics 100′ comprising a fiber laser 3′, a collimator 4′ and a rotatable cylindrical lens 6a′. In order to align light sheets 8 and 8′, illumination optics 100 may be translated in sheet translation direction 5 and illumination optics 100′ may be translated in a sheet translation direction 5′. Use of dual light sheets as shown in FIG. 1D may be advantageous for certain samples. For example, if the light intensity within the sample is severely attenuated due to light scattering by the sample material or by artefacts within the sample, then illumination from two sides of the sample may provide enhanced imaging capability.

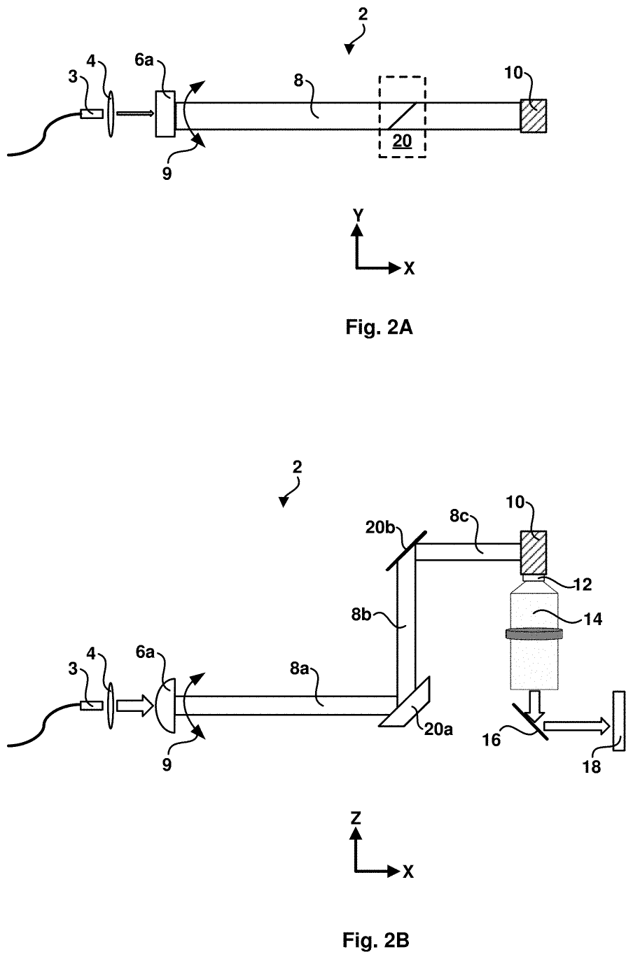

FIG. 2A is a schematic top view of an optical system 2 for a light sheet microscope, and FIG. 2B is a schematic side view of optical system 2. Optical system 2 has the same components as optical system 1, with addition of a mirror set 20 comprising a bottom mirror 20a and a top mirror 20b. The purpose of mirror set 20 is to allow light sheet generating components 3, 4 and 6a to be in a different plane in the Z direction from sample 10, which may be convenient in the overall design of the light sheet microscope. Light sheet generating components 3, 4 and 6a generate a light sheet section 8a, which is reflected to a light sheet section 8b by bottom mirror 20a, and then to a light sheet section 8c by top minor 20b.

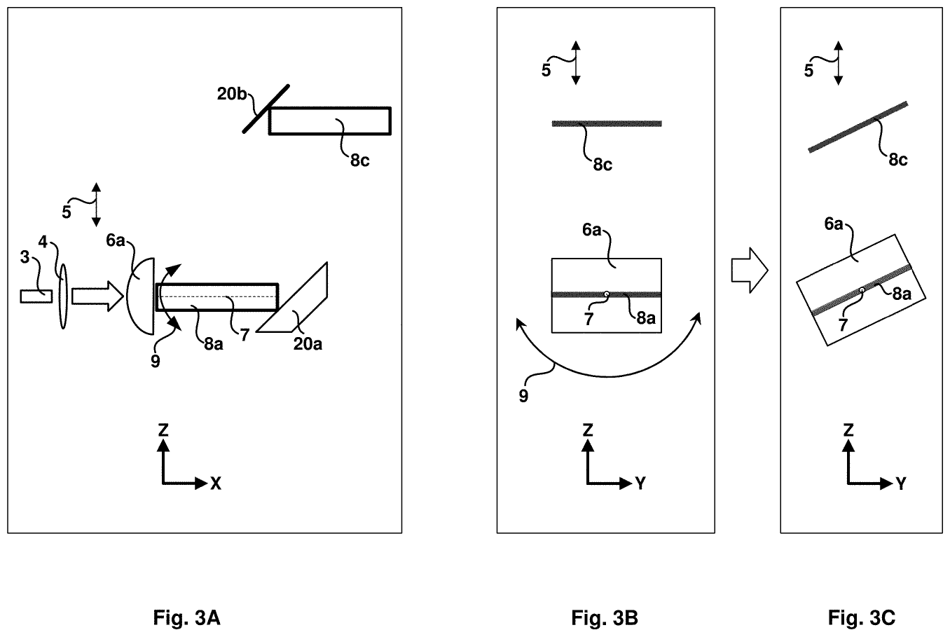

FIG. 3A is a partial schematic side view of optical system 2, in which light sheet section 8b has been omitted for clarity. FIGS. 3B and 3C are partial schematic end views of optical system 2, illustrating how rotation of cylindrical lens 6a about rotation axis 7 causes rotation of both light sheet sections 8a and 8c. The optical arrangement of FIGS. 3A, 3B and 3C ensures that rotation of light sheet section 8c follows the rotation of light sheet section 8a, such that the planes of light sheet sections 8a and 8c always remain parallel to one another. This is true provided that mirrors 20a and 20b are inclined at the same inclination angle to rotation axis 7. In the preferred embodiment, the inclination angle is 45°, such that the rotation axes of light sheet sections 8a and 8c are parallel. Thus, optical system 2 enables generation of rotatable light sheet 8c which is incident on sample 10.

FIG. 4A is a schematic illustration showing alignment of rotatable light sheet 8 and tilted focal plane 26. In the absence of tilting device 12, objective lens 14 has a normal focus 22 and normal focal plane 23 which is substantially perpendicular to optical axis 13. In the presence of tilting device 12, objective lens 14 has a tilted focus 24 and tilted focal plane 26 which is tilted at an angle to normal focal plane 23. For optimal performance of the light sheet microscope, rotation 9 and translation 5 of light sheet 8 should be adjusted so that the plane of light sheet 8 is coincident with tilted focal plane 26.

As shown above, it should be noted that one of the novel aspects of the invention is to provide at least one illumination optics producing at least one rotatable light sheet, and a detection optics providing a tilted focal plane. Another novel aspect is to provide alignment mechanisms so that the corresponding light sheet and tilted focal plane are aligned to be substantially coincident prior to conducting a measurement or a series of measurements.

FIG. 4B illustrates an embodiment of tilting device 12 in which the optical tilting is implemented by means of a prism 27. Prism 27 generates tilted focal plane 26 of objective 14, wherein tilted focal plane 26 is substantially coincident with light sheet 8. Light sheet 8 is incident on sample 10 carried in a multiple sample carrier 32, which is translated in a sample translation direction 29. FIG. 4C illustrates another embodiment of tilting device 12 in which tilting of tilted focal plane 26 is implemented by means of a mirror 31. A single plane mirror 31 is shown in FIG. 4C, however multiple mirrors, or one or more curved mirrors, may be used to achieve the desired optical result. FIG. 4D illustrates yet another embodiment of tilting device 12 in which tilting of tilted focal plane 26 is implemented by means of a graded refractive index lens 33. Graded refractive index lens 33 is made of a material in which the refractive index varies with position in the lens. For graded refractive index lens 33 having a side 33a and a side 33b as illustrated in FIG. 4D, the refractive index is higher on side 33a than on side 33b. Graded refractive index lens 33 may have a fixed refractive index gradient, or it may comprise an electronically controlled gradient index device made of a material in which the refractive index of different parts of the device may be changed electronically, for example by application of voltages to the device. Such an electronically controlled gradient index device provides the capability for real time control of the tilt angle of tilted focal plane 26.

Note that the foregoing embodiments of tilting device 12 are not intended to be limiting. Other optical devices capable of tilting the focal plane of objective lens 14 are possible, and all such devices are within the scope of the present disclosure.

It should be noted that, if the tilting angle is large (greater than about 30 degrees), the various embodiments of tilting device 12 described above may cause optical aberrations which might adversely affect the quality of the sample image. For example, prism 27 may cause chromatic aberrations of the image. The function of aberration correcting device 17 (see FIG. 1C) is to compensate any such aberrations, thereby improving the image quality. In FIG. 1C, aberration correcting device 17 is shown located between reflecting mirror 16 and light detecting device 18, however other locations of aberration correcting device 17 within detection optics 200 are possible and all such locations are within the scope of the present disclosure.

Aberration correcting device 17 may comprise a single optical element or multiple optical elements. In an embodiment, aberration correcting device 17 comprises a single prism configured to primarily compensate chromatic aberrations introduced by tilting device 12. In another embodiment, aberration correcting device 17 comprises a liquid crystal on silicon (LCoS) device. A LCoS device is two-dimensional array of pixels, each pixel comprising a layer of liquid crystal material whose refractive index may be varied by application of voltage to the pixel. Spatially varying the refractive index of pixels over the surface of the LCoS array allows aberrations to be compensated in images transmitted through the array, the compensation being adjustable in real time.

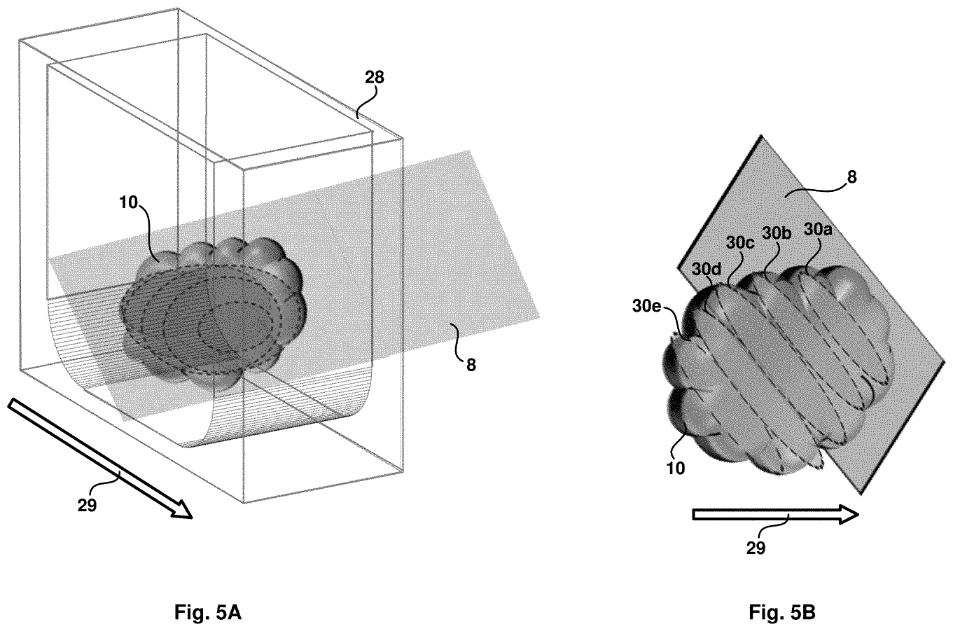

FIG. 5A illustrates a representative sample 10 located in a sample holder 28 which is translated in sample translation direction 29. Note that sample translation direction 29 does not lie in the plane of tilted light sheet 8. In a preferred embodiment, sample translation direction 29 is in a horizontal direction substantially perpendicular to rotation axis 7 and to optical axis 13. FIG. 5B is an expanded view of sample 10 showing intersection planes 30a, 30b, 30c, 30d, and 30e, which are planes of intersection of light sheet 8 with sample 10 as sample 10 is translated. Note that for each intersection plane, image acquisition system 19 may acquire a planar image of the emitted fluorescent light, each planar image being a slice of a full three-dimensional image of sample 10 which is built up during a single sweep of sample 10 through light sheet 8.

FIG. 6 is a diagram showing intersection of light sheet 8 with multiple samples in multiple sample carrier 32. Multiple sample carrier 32 is translated in sample translation direction 29 such that light sheet 8 sweeps through each of the multiple samples. Thus, in a single translation pass of multiple sample carrier 32, light sheet 8 sweeps through all of the multiple samples, and image acquisition system 19 may acquire, in the course of the single pass, full three-dimensional images of all of the multiple samples. Note that the ability to acquire three-dimensional images of multiple samples in a single pass of multiple sample carrier 32 is a key aspect of the present disclosure. Note also that, although multiple sample carrier 32 is depicted in FIG. 6 as a linear carrier with linear motion, other carrier configurations such as a circular carrier with rotational motion are possible, and all such variations of carrier configuration are within the scope of the present disclosure.

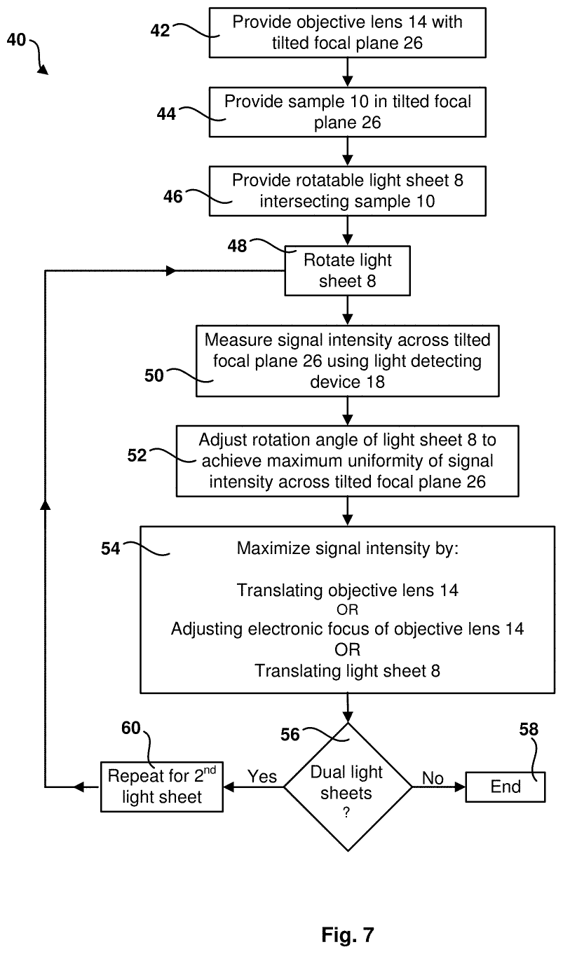

FIG. 7 is a flowchart of a method 40 of adjusting an optical system of a light sheet microscope. Referring to FIG. 7, in step 42 objective lens 14 is provided with tilting device 12 forming tilted focal plane 26. In step 44, sample 10 is provided in tilted focal plane 26. Sample 10 may be a phantom sample for the purpose of adjustment of the optical system. In step 46, rotatable light sheet 8 is provided intersecting sample 10. In step 48, light sheet 8 is rotated while, in step 50, the signal intensity of emitted light across tilted focal plane 26 is measured with two-dimensional light detecting device 18. In step 52, the rotation angle of light sheet 8 is adjusted to achieve maximum uniformity of signal intensity across tilted focal plane 26. Note that maximum uniformity of signal intensity is a measure of the parallelism of the plane of light sheet 8 and tilted focal plane 26. In an embodiment, maximum uniformity may be determined by minimizing the standard deviation of pixel intensity over the area of light detecting device 18.

Still referring to FIG. 7, in step 54 the total signal intensity from light detecting device 18 is maximized. Note that maximum signal intensity is a measure of the coincidence of the plane of light sheet 8 and tilted focal plane 26. The maximization may be achieved by adjusting the focus of objective lens 14, either by translating detection optics 200 in detection translation direction 15, or by adjusting an electronic focusing device associated with objective lens 14. Alternatively, maximization of signal intensity may be achieved by translating light sheet 8 in sheet translation direction 5. Step 56 of method 40 is a determination of whether there are dual light sheets. If not, method 40 terminates at step 58. If there is a second light sheet, adjustment of that sheet is carried out starting at step 48 and terminating at step 54.

Thus, by maximizing uniformity to achieve parallelism in step 52, and maximizing intensity to achieve coincidence in step 54, adjustment method 40 ensures co-planarity of light sheet 8 with tilted focal plane 26.

It should be noted that the “adjusting steps” associated with method 40 are preferably used as a periodic calibration procedure prior to testing one or more batches of samples. Once maximum uniformity and intensity of the light signal have been achieved, rotation of the illumination optics and other optical translations of method 40 are not required until the next calibration procedure.

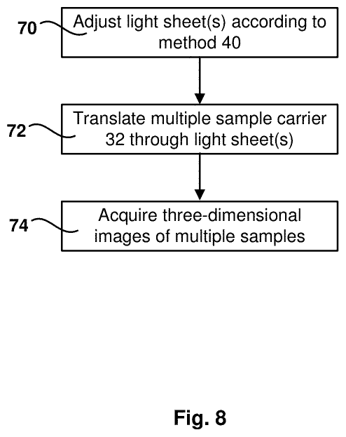

FIG. 8 is a flowchart of a method of generating three-dimensional images of multiple samples. One or more light sheets are adjusted in step 70 as described in connection with method 40 of FIG. 7. In step 72, multiple sample carrier 32 is translated in sample translation direction 29 such that there is a single sweep of all the multiple samples through the one or more light sheets. In step 74, image acquisition system 19 acquires three-dimensional images of all the samples from the single sweep. Note that, optionally, further sweeps of the multiple samples through the light sheet(s) may be carried out in order to obtain time-lapse images of living samples.

Although the present invention has been described in relation to particular embodiments thereof, it can be appreciated that various designs can be conceived based on the teachings of the present disclosure, and all are within the scope of the present disclosure.

What is claimed is,:

1. A light sheet microscope comprising:
a set of detection optics configured to detect an emitted light from a sample, the detection optics comprising an objective lens having an optical axis and a normal focal plane perpendicular to the optical axis;
a tilting device configured to tilt the normal focal plane of the detection optics such that a tilted focal plane is tilted with respect to the normal focal plane; and,
an illumination optics generating at least one tilted light sheet, the illumination optics comprising at least one light sheet rotation device, wherein the light sheet rotation device is configured to rotate the light sheet about a rotation axis such that a light sheet plane of each of the at least one tilted light sheet is substantially coincident with the tilted focal plane.

2. The microscope of claim 1 further comprising a translating stage configured to move the sample through the at least one tilted light sheet in a sample translation direction, thereby generating the emitted light, and wherein the sample translation direction is not in the light sheet plane.

3. The microscope of claim 2 wherein the optical axis is vertical, the rotation axis is substantially perpendicular to the optical axis and the sample translation direction is substantially perpendicular to the rotation axis and the optical axis.

4. The microscope of claim 1 wherein the light sheet rotation device is a cylindrical lens configured to rotate about the rotation axis.

5. The microscope of claim 1 wherein the tilting device is a prism located between the objective lens and the sample.

6. The microscope of claim 1 wherein the tilting device is at least one mirror located between the objective lens and the sample.

7. The microscope of claim 1 wherein the tilting device is a gradient refractive index lens located between the objective lens and the sample.

8. The microscope of claim 1 wherein the tilting device is an electronically controlled gradient index device located between the objective lens and the sample.

9. The microscope of claim 2 wherein the translating stage carries multiple samples and wherein each of the multiple samples is sequentially translated through the at least one tilted light sheet in a single translation step of the translating stage.

10. The microscope of claim 9 further comprising an image acquisition system configured to acquire data to form a three-dimensional image of the emitted light from each of the multiple samples during the single translation step.

11. The microscope of claim 4 further comprising a light detecting device for measuring a total intensity and a uniformity of intensity of the emitted light in the tilted focal plane.

12. The microscope of claim 11 further comprising a rotation mechanism for rotating the cylindrical lens so as to maximize the uniformity of intensity.

13. The microscope of claim 11 further comprising an illumination optics translation mechanism for translating the illumination optics in a direction substantially parallel to the optical axis so as to maximize the total intensity.

14. The microscope of claim 11 further comprising a detection optics translation mechanism for translating the detection optics and the tilting device in a direction substantially parallel to the optical axis so as to maximize the total intensity.

15. The microscope of claim 11 wherein the detection optics comprises an electronically tunable lens and wherein the electronically tunable lens may be adjusted to maximize the total intensity.

16. The microscope of claim 1 wherein the detection optics further comprises an aberration correcting device configured to correct optical aberrations caused by the tilting device.

17. The microscope of claim 16 wherein the aberration correcting device is a prism.

18. The microscope of claim 16 wherein the aberration correcting device is a liquid crystal on silicon (LCoS) device.

19. A method of adjusting an optical system for a light sheet microscope, the method comprising the steps of:
providing a detection optics comprising an objective lens having an optical axis and a normal focus plane perpendicular to the optical axis, the detection optics further comprising a light detecting device for measuring a total intensity and a uniformity of intensity of an emitted light from a sample;
providing a tilting device configured to tilt a focal plane of the detection optics such that a tilted focal plane is tilted with respect to the normal focus plane;
providing an illumination optics generating at least one tilted light sheet, each of the at least one tilted light sheet having a light sheet plane; and,
rotating the light sheet plane to maximize the uniformity of intensity.

20. The method of claim 19, further comprising the step of translating the illumination optics in a direction substantially parallel to the optical axis so as to maximize the total intensity.

21. The method of claim 19, further comprising the step of translating the detection optics and the tilting device in a direction substantially parallel to the optical axis so as to maximize the total intensity.

22. The method of claim 19 wherein the detection optics comprises an electronic lens and the method further comprises the step of adjusting the electronic lens so as to maximize the total intensity.

23. The method of claim 19 wherein steps of the method represent steps for a calibration of the microscope.

24. A method of generating a three-dimensional image of an emitted light from each one of multiple samples with a light sheet microscope, the method comprising the steps of:
providing a detection optics comprising an objective lens having a vertical optical axis and a normal focus plane perpendicular to the optical axis, the detection optics configured to detect the emitted light;
providing a tilting device configured to tilt a focal plane of the detection optics such that a tilted focal plane is tilted with respect to the normal focus plane;
providing an illumination optics generating at least one tilted light sheet, each of the at least one tilted light sheet having a light sheet plane;
rotating the light sheet plane so that it is substantially coincident with the tilted focal plane;
translating the multiple samples in a translation direction which is not in the light sheet plane, wherein the multiple samples are sequentially translated in a single translation step through the at least one tilted light sheet, thereby generating the emitted light; and,
generating the three-dimensional image of each one of the multiple samples from the emitted light during the single translation step.
